(19) United States
(12) Patent Application Publication
(10) Pub. No.: US 2011/0247905 A1
(43) Pub. Date: Oct. 13, 2011

(54) BRAKE CALIPER

(76) Inventors: Paul Anthony Thomas, Newport (GB); Simon Scott Fisher, Monmouthshire (GB)

(21) Appl. No.: 13/041,806

(22) Filed: Mar. 7, 2011

(30) Foreign Application Priority Data
Apr. 7, 2010 (GB) 1005763.6

(51) Int. Cl. F16D 65/00; F16D 55/22; F16D 55/226; F16D 65/095

(52) U.S. Cl. 188/73.31; 188/73.43

(57) ABSTRACT

A brake caliper has a first side and a second side with a recess between the first and second sides for receiving a brake rotor. The brake caliper includes a housing for receiving a brake actuator mechanism, and the housing is on the first side and has a first part and a second part. The second part is positioned between the first part and the second side. The first part includes a single slide pin hole, the second part includes a first slide pin hole and a second slide pin hole, and the single slide pin hole is concentric with one of the first and second slide pin holes. The caliper further includes a first slide pin received in and supported by the single slide pin hole and the one of the first and second slide pin holes, and a second slide pin received in and supported by another of the first and second slide pin holes.

### REFERENCE TO RELATED APPLICATION

This application claims priority to United Kingdom Application No. GB 1005763.6 filed Apr. 7, 2010.

### BACKGROUND OF THE INVENTION

The present invention relates to brake calipers, in particular brake calipers for heavy road going vehicles, such as trucks and lorries.

Sliding caliper brakes are known where the caliper includes an actuator mechanism on one side (typically the inboard side). The caliper is slideably mounted on pins. When the brake is applied, the actuator moves the inboard brake pad outwardly until such time as it engages the brake rotor. Reaction forces then cause the caliper to slide inboard, on the pins, such that the outboard brake pad is moved inwardly and engages the rotor, thereby braking the vehicle.

In some embodiments, the pins are fixed, and the caliper is mounted on the pins via holes in the caliper. Clearly, the pins and holes must be designed such that they can withstand the various forces occurring during braking. Furthermore, the pins and holes must be designed to be sufficiently durable. Thus, where space permits, the pins are relatively long so as to provide sufficient bearing surfaces.

However, under certain circumstances, the space availability for the pins may be limited, in particular on the rear axle of trucks. On such vehicles, the caliper is typically mounted in a vertical orientation, i.e., it is mounted at the front of the rotor or at the rear of the rotor. Under these circumstances, a chassis rail of the vehicle may encroach on the space available for one of the pins. As such, it is necessary to modify the design of the caliper to make the pin shorter.

FIG. 6 of German Gebrauchmuster number G9208699 shows a sliding caliper brake having one relatively long pin and one relatively short pin. The caliper has a main body and a cover which includes a flange for an air cylinder. The region of the main body of the caliper in the region of the short pin has been “cut away” so as to miss some vehicle structure, such as a chassis rail. This results in an asymmetrical main body. Typically, the main body will be made from a casting. The caliper for the opposite side of the vehicle will be opposite handed, i.e., the right and left hand calipers on the vehicle will typically be mirror images of each other. This enables the opposite caliper to miss the equivalent vehicle structure (such as the opposite chassis rail) on its side of the vehicle. For this reason, it is necessary to make opposite handed molds in order to cast a left and right hand version of the main body. It is also necessary to have different machining operations on each main body, i.e., one is machined as a left hand version, and one is machined as a right hand version. The covers also have to be made as left or right handed versions. This results in a more expensive set of calipers for an axle. Thus, one object of the present invention is to provide a design of caliper that is cheaper to manufacture.

### SUMMARY OF THE INVENTION

Thus, there is provided a brake caliper having a first side and a second side with a recess between the first and second sides for receiving a brake rotor. The brake caliper includes a housing for receiving a brake actuator mechanism. The housing is on the first side and having a first part and a second part, the second part being positioned between the first part and the second side. The first part includes a single slide pin hole, the second part includes a first slide pin hole and a second slide pin hole, and the single slide pin hole is concentric with one of the first and second slide pin holes. The caliper further includes a first slide pin received in and supported by the single slide pin hole and the one of the first and second slide pin holes, and a second slide pin received in and being supported by another of the first and second slide pin holes.

The first slide pin is received in both the single side pin hole of the first part and in one of the slide pin holes of the second part, allowing the first slide pin to be relatively long. The second slide pin is received in just one of the slide pin holes of the second part (and not being received in any slide pin hole of the first part), enabling the second slide pin to be relatively short. Stating it another way, both slide pin holes in the second part can be made relatively short with the extra length required for the long slide pin being made up by the single slide pin hole of the first part. In this way, the second part on the right hand side of the vehicle can be identical to the second part on the left hand side of the vehicle. All that is then required is to make opposite handed versions of the first part. This therefore allows for one common part which can be fitted on either side of the vehicle.

As best seen in FIG. 8 of German Gebrauchmuster G 9208699, the caliper has a housing for receiving the twin adjustable tappets and the operating shaft. The housing is closed by a cover against which the operating shaft reacts. Operation of the brake causes deflection in the cover.

A caliper is also provided where the operating shaft reacts against a component, which is relatively stiff.

Thus, there is also provided a brake caliper including a first side and a second side with a recess between the first and second sides for receiving a brake rotor. The brake caliper includes a housing for receiving a brake actuator mechanism, and the housing is on the first side and having a first part and a second part. The second part is positioned between the first part and the second side, the first part engaging the second part at an interface which defines a joint plane. The brake caliper includes a brake actuator mechanism having an actuating shaft rotatable about an axis orientated parallel to the joint plane, and the axis is positioned on a side of the joint plane opposite the second part.

Where the first side is an inboard side and the second side is an outboard side, providing the joint plane outboard of the rotational axis of the actuating shaft necessarily requires a housing having a first part which is relatively deep and therefore relatively stiff compared with a generally flat cover.

### BRIEF DESCRIPTION OF THE DRAWINGS

The invention will now be described, by way of example only, with reference to the accompanying drawings in which:

FIG. 1 is an isometric view of the brake caliper;

FIG. 2 is a schematic cross-section view of the brake caliper of FIG. 1:

FIG. 3 is a schematic plan view of part of the brake caliper of FIG. 1:

FIG. 4 is an isometric view of part of the brake caliper of FIG. 1:

FIG. 5 is an isometric view of part of a second brake caliper;

FIG. 6 is plan view of the brake caliper of FIG. 1;

FIG. 7 is a plan view of a second embodiment of a brake caliper incorporating the components of FIG. 5:

FIG. 8 is a plan view of a third embodiment of a brake caliper according to the present invention: and

FIG. 9 is a plan view of a fourth embodiment of brake caliper according to the present invention.

### DETAILED DESCRIPTION OF THE PREFERRED EMBODIMENT

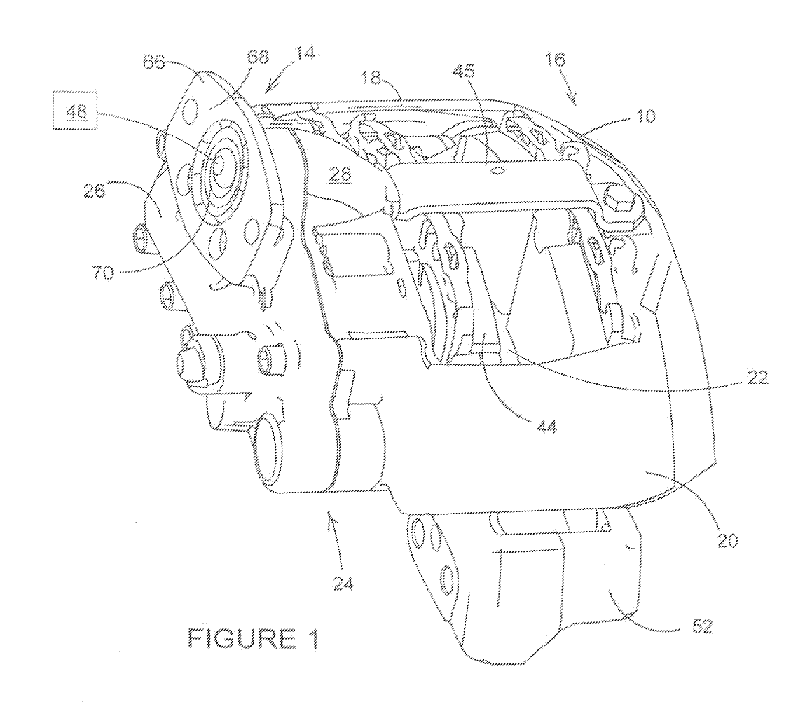

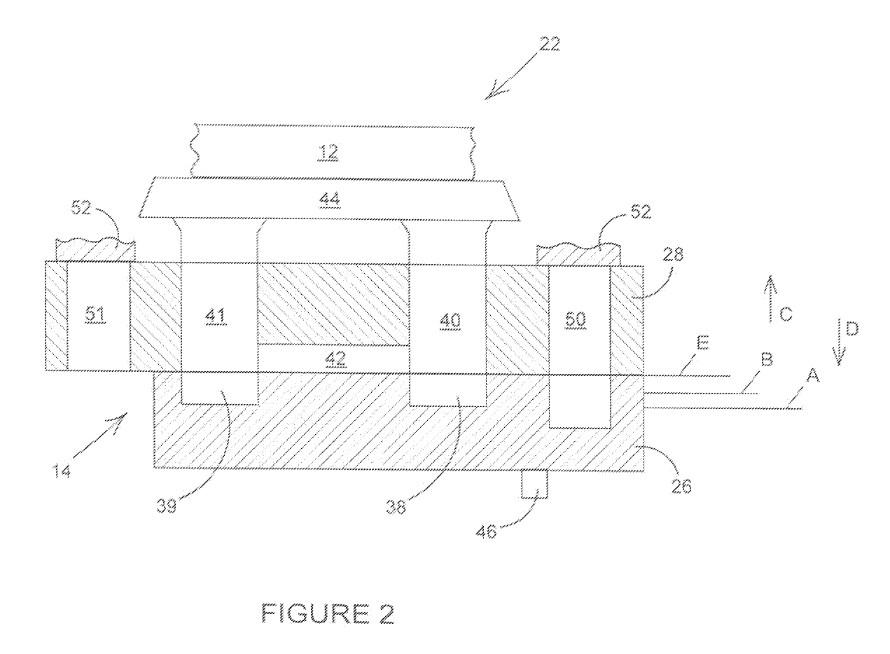

With reference to FIGS. 1 to 4 and 6, there is shown a brake caliper 10 which straddles a brake rotor 12. The brake caliper 10 has a first side 14 and a second side 16. The first and second sides 14 and 16 are connected by bridge arms 18 and 20. A recess 22 is defined between the first and second sides 14 and 16 and receives the brake rotor 12.

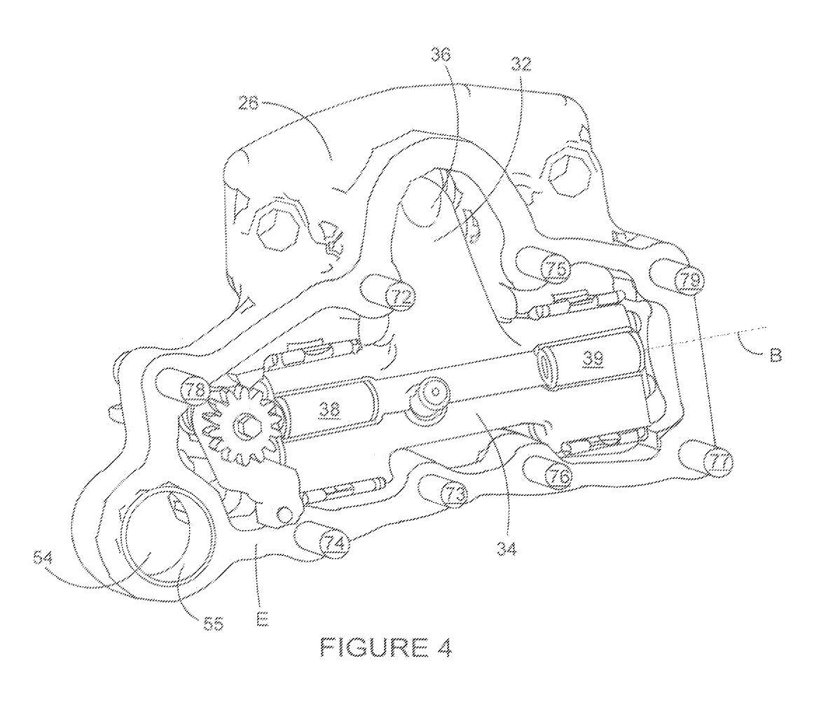

On the first side 14, there is defined a two part housing 24 having a first part 26 and a second part 28. Contained within the two part housing 24 is a brake actuator mechanism 30. The brake actuator mechanism 30 consists primarily of an operating shaft 32 which is generally T-shaped having a shaft portion 34 and a lever portion 36. Mounted on the shaft portion 34 at opposite ends are rollers 38 and 39. The operating shaft 32 is rotatable about an axis A, which is offset from an axis B of the rollers 38 and 39. As can be seen from FIG. 4, the operating shaft 32 is mounted in the first part 26 of the two part housing 24. Mounted in the second part 28 of the two part housing 24 is a pair of adjustable tappets 40 and 41, and an adjuster mechanism 42 automatically adjusts the adjustable tappets 40 and 41, which compensate for wear of brake pads 44 and 45. A de-adjuster mechanism 46 allows de-adjustment of the adjustable tappets 40 and 41 when worn brake pads are to be replaced by new brake pads.

The brake actuator mechanism 30 per se is well known, as is its operation. However, in summary, an air actuator 48 (shown schematically) acts on an end of the lever portion 36, causing the operating shaft 32 to rotate about the axis A, which in turn causes the rollers 38 and 39 to move in the direction of an arrow C, thereby engaging and forcing the adjustable tappets 41 and 42 and hence the brake pad 44 in the direction of the arrow C until such time as it engages the brake rotor 12. Reaction forces then cause the brake caliper 10 to move in the direction of an arrow D until such time as the brake pad 45 engages the brake rotor 12, which is then clamped between the brake pads 44 and 45 to apply the brake.

The brake caliper 10 moves in the direction of the arrow D by virtue of it being mounted on slide pins 50 and 51. The slide pins 50 and 51 are secured to a carrier 52, which is fixed relative to an axle or other vehicle structure.

As mentioned above, the brake actuator mechanism 30 is contained within the two part housing 24. The first part 26 of the two part housing 24 engages the second part 28 of the two part housing 24 at an interface which defines a joint plane E.

The first part 26 includes a single slide pin hole 54, one end of which terminates at the joint plane E. Positioned within the slide pin hole 54 is a bush 55 which projects from the single slide pin hole 54, and in particular projects beyond the joint plane E. The second part 28 of the two part housing 24 includes a first slide pin hole 60 having a bush 61 and a second slide pin hole 62 with a bush 63.

One end of the first slide pin hole 60 terminates at the joint plane E. One end of the second slide pin hole 62 terminates at the joint plane E. The end of the bush 61 nearest the joint plane E is recessed into the first slide pin hole 60 by an amount slightly more than the amount by which the bush 55 projects past the joint plane E. An end of the bush 63 is positioned flush with the joint plane E.

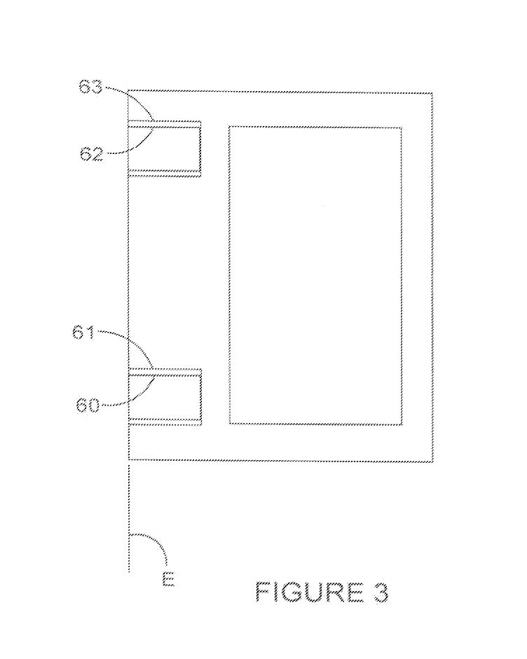

To assemble the brake caliper 10, the operating shaft 32, the rollers 38 and 39 and the de-adjuster mechanism 46 are assembled into the first part 26, as shown in FIG. 4. The adjustable tappets 40 and 41 and the adjuster mechanism 42 are assembled into the second part 28, as shown in FIG. 3. The first and second parts 26 and 28 are then brought together. During this process, because the bush 55 projects beyond the joint plane E, just prior to the first part 26 contacting the second part 28 at the joint plane E, the bush 55 will enter the first slide pin hole 60, thereby ensuring that the bush 55 is correctly aligned with the bush 61. The slide pin 50 (which is relatively long) is then inserted into the hole formed by bushes 61 and 55. The slide pin 51 (which is relatively short) is then inserted into the hole formed by bush 63. Bolts are then used to secure the slide pins 50 and 51 to the carrier 52, which typically will be prefitted to one side of an axle.

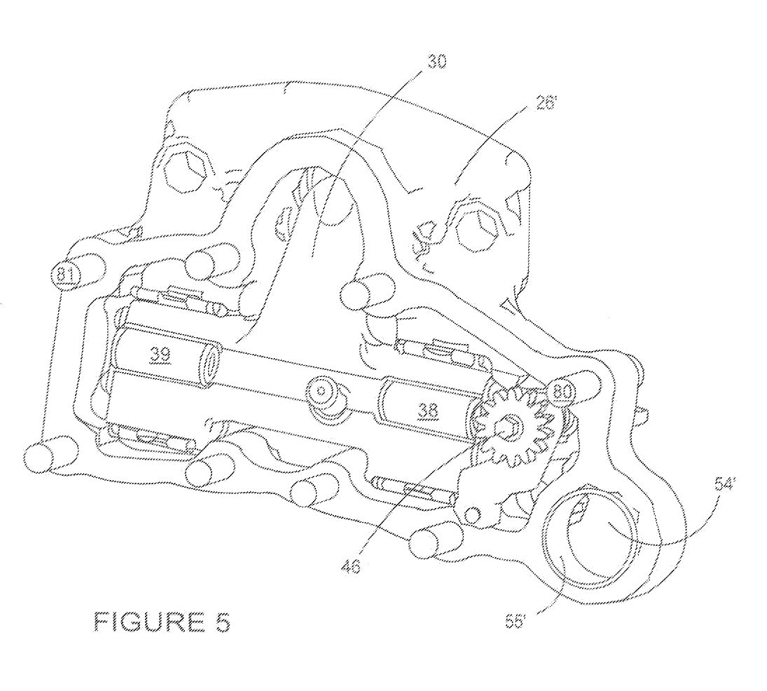

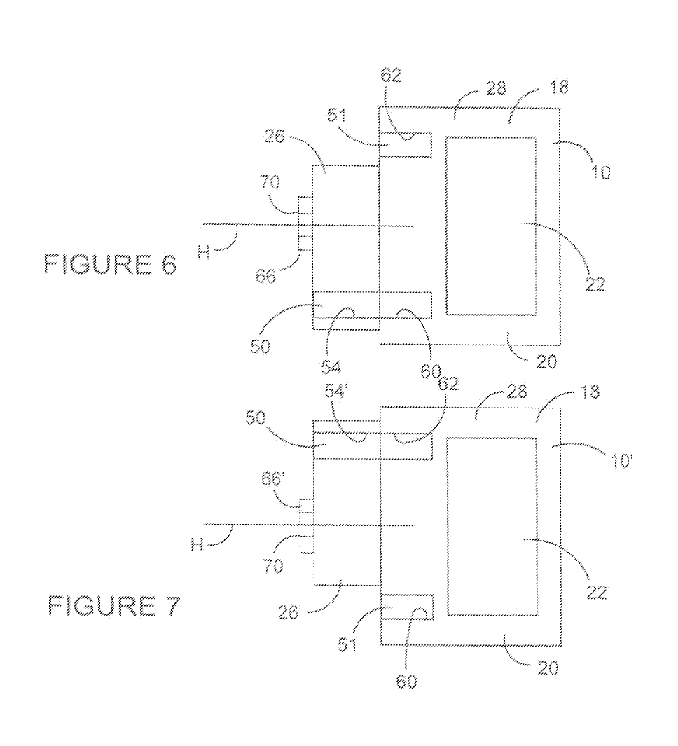

To fit a brake caliper 10 on the opposite side of the axle, the identical second part 28 can be used in conjunction with an opposite handed first part 26′ (see FIG. 5). As can be seen in FIGS. 6 and 7, in the brake caliper 10′, which is to be fitted on the opposite side of the vehicle as the brake caliper 10, the second part 28 is identical on both brake calipers 10, and the first part 26 on the brake caliper 10 is an opposite handed version of the first part 26′ of the brake caliper 10′. On the brake caliper 10, the relatively long slide pin 50 is inserted into the single slide pin hole 54 and the first slide pin hole 60. On the brake caliper 10′, the relatively long slide pin 50 is fitted in the single slide pin hole 54′ and the second slide pin hole 62.

The first part 26 includes a flange 66 which defines a plane 68 against which the air actuator 48 fits. Depending upon the particular installation, the first part 26 can be designed with the plane in various orientations. In one embodiment, the plane 68 may be parallel to the joint plane E. In another embodiment, (the embodiment shown in FIGS. 1 and 6), an axis H of the hole 70 of the flange 66 through which an air actuator rod passes may intersect an axis of rotation of the brake rotor 12. In another embodiment, the axis of the hole 70 may not intersect an axis of rotation of the brake rotor 12, i.e., the axis of the hole 70 may be skewed relative to the axis of rotation of the brake rotor 12.

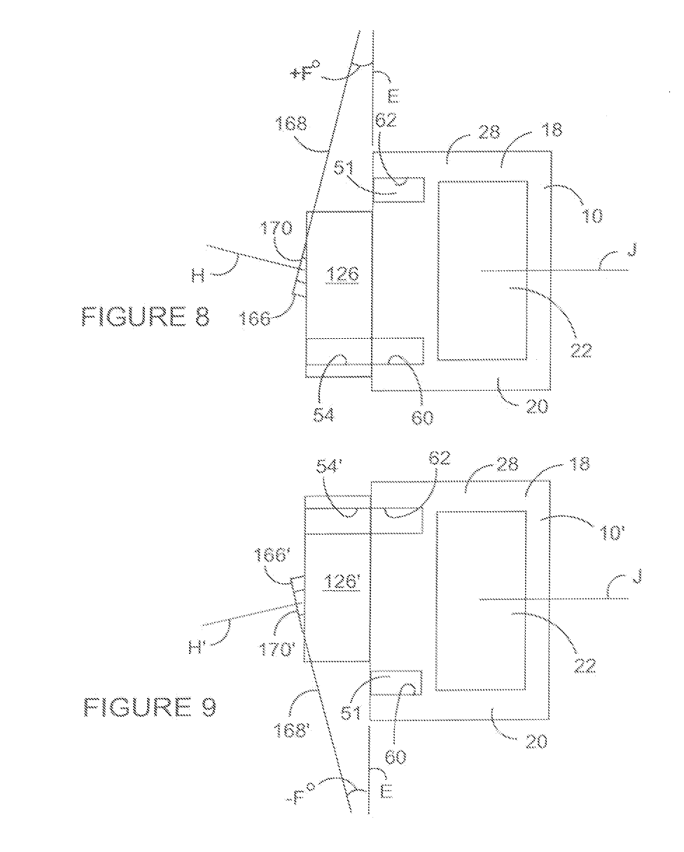

FIG. 8 show an alternative first part 126 having an air cylinder flange 166 with a hole 170, the axis H of which is skewed relative to an axis J of rotation of the rotor. FIG. 9 shows an opposite handed first part 126′ where the flange 166′ has been “skewed” in the opposite direction. Thus, the angle that the plane 168 makes with the joint plane E is +F.°, and the angle the plane 168′ makes with joint plane E is F.°.

Thus, the flange 166 is orientated in a first manner relative to the joint plane E, and the flange 166′ is orientated in a second manner, different from the first manner, relative to the joint plane E. In this example, the plane 168 is orientated in an opposite manner to the plane 168′. In further embodiments, the plane of the two flanges 166 and 166′ need not be orientated in an opposite manner.

Since the first part 126 is different from first part 126′ by virtue of the different positioning of the single slide pin holes 54 and 54′ then, where necessary, it is relatively simple to design and manufacture the first parts where the flanges 166 and 166′ are orientated in different manners. As mentioned above, the second part 28 of the brake caliper 10 is identical to the second part 28 of the brake caliper 10′.

Bolts 72, 73 and 74 are symmetrically disposed relative to bolts 75, 76 and 77, respectively. However, a bolt 78 is not symmetrically disposed relative to a bolt 79. As such, as the first part 26 is bolted onto the second part 28 just using eight bolts, the second part 28 has ten threaded bolt holes corresponding to bolts 72, 73, 74, 75, 76, 77, 78, 79, 80 to 81. In the brake caliper 10, bolt holes in the second part 28 corresponding to the bolts 80 and 81 are not used. In the brake caliper 10′, the bolt holes in the second part 28 corresponding to the bolts 78 and 79 are not used. In this instance, the expense of drilling and tapping holes which may be redundant on a particular installation is more than offset by the savings made by having a single part number for the second part 28.

However, in further embodiments, it may be more economical to have a common casting for the second part 28, but to machine this common casting differently to provide for left and right hand versions. For example, in a further embodiment, the second part 28 of the brake caliper 10 may not have holes corresponding to the bolts 80 and 81, whereas the second part 28 of the brake caliper 10′ may not have holes corresponding to the bolts 78 and 79. Thus, depending upon particular circumstances, it may be beneficial to have a common casting (or a common forging) and machine this common casting/forging slightly differently depending upon the circumstances.

In a further embodiment, the bolting pattern of the bolts that secure the first part 26 to the second part 28 could be symmetrical, and this would result in a second part 28 having no redundant holes.

As mentioned above, the single slide pin hole 54 terminates at the joint plane E. This simplifies manufacture, since the joint plane E can be machined at the same time as the end of the single slide pin hole 54. In further embodiments, the end of the single slide pin hole 54 may not terminate at the joint plane E. Similarly, the ends of the first slide pin hole 54 and/or second slide pin hole 56 may not terminate at the joint plane E.

As mentioned above, the bush 55 projects from the single slide pin hole 54 beyond the joint plane E. In further embodiments, the bush 55 and/or the bush 61 and/or the bush 63 could terminate at the joint plane E, or could terminate below the joint plane E, or could terminate above the joint plane E.

As mentioned above, the bush 55 projects beyond the joint plane E, and under these circumstances the opposing bush 61 or 63, depending upon whether a right or left hand version of the brake caliper 10 is being made, could terminate below the joint plane E. In an alternative embodiment, the bush 55 could terminate below the joint plane E, and the opposing bush 61 or 63, depending upon whether a right or left handed version of the brake caliper 10 was being made, could terminate above the joint plane E. Such an arrangement would still provide for correct alignment of the bush 55 with its covers providing bush on assembly.

In an alternative embodiment, the first and second parts 26 and 28 could be assembled without the bush 55 and without the bush opposite the bush 55. Once assembled, a single longer bush could be inserted into the first pin hole and the corresponding hole in the second part 28.

As described above, the second part 28 forms part of two part housing 24 and is integrally formed with the bridge arms 18 and 20 and with the second side 16. This component is machined from a casting and hence the second part 28, the bridge arms 18 and 20 and the second side 16 are unitary. In further embodiments, the second part 28 may be a separate component from the second side 16. For example, the second side 16 and the bridge arms 18 and 20 may be made from a single casting and therefore unitary. This unitary component could then be bolted, or otherwise fixed to the second part 28, which itself could be made from a casting or forging. Such a sub assembly could be used to make opposite handed calipers, i.e., such a sub assembly could be used on the right hand side of the vehicle and on the left hand side of the vehicle by providing appropriate first parts. EP0995923 shows an example of the caliper wherein the bridge arms and outboard part of the caliper are bolted to the inboard part of the caliper. The outboard part (or that part of the caliper opposite the actuator mechanism, herein referred to as the second side) and the bridge arms of the present invention could be bolted to the first part of the present invention in a similar manner.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A brake caliper comprising:
a first side and a second side with a recess between the first side and the second side for receiving a brake rotor;
a housing for receiving a brake actuator mechanism, wherein the housing is located on the first side and includes a first part and a second part, the second part is positioned between the first part and the second side, the first part includes a single slide pin hole, the second part includes a first slide pin hole and a second slide pin hole, and the single slide pin hole is concentric with one of the first slide pin hole and the second slide pin hole;
a first slide pin received in and supported by the single slide pin hole and the one of the first slide pin hole and the second slide pin hole; and
a second slide pin received in and supported by the other of the first slide pin hole and the second slide pin hole.

2. The brake caliper as defined in claim 1 wherein the first part engages the second part at an interface which defines a joint plane, the single slide pin hole terminates at or near the joint plane, the first slide pin hole terminates at or near the joint plane, and the second slide pin hole terminates at or near the joint plane.

3. The brake caliper as defined in claim 2 wherein each of the single slide pin hole, the first slide pin hole and the second slide pin hole terminate at the joint plane.

4. The brake caliper as defined in claim 2 wherein at least one of the single slide pin hole terminates on a side of the joint plane remote from the second side, the first slide pin hole terminates on a side of the joint plane proximate the second side, and the second slide pin hole terminates on a side of the joint plane proximate the second side.

5. The brake caliper as defined in claim 1 wherein the single slide pin hole receives a bush, and the bush projects at least partially into the one of the first slide pin hole and the second slide pin hole.

6. The brake caliper as defined in claim 1 wherein the one of the first slide pin hole and the second slide pin hole receives a bush, and the bush projects at least partially into the single slide pin hole.

7. The brake caliper as defined in claim 1 including a brake actuator mechanism having an actuating shaft rotatable about an axis orientated substantially parallel to the joint plane, and the axis is positioned on a side of the joint plane opposite the second part.

8. A set of brake calipers comprising:
a first brake caliper and a second brake caliper each including:
a first side and a second side with a recess between the first side and the second side for receiving a brake rotor,
a housing for receiving a brake actuator mechanism, wherein the housing is located on the first side and includes a first part and a second part, the second part is positioned between the first part and the second side, the first part includes a single slide pin hole, the second part includes a first slide pin hole and a second slide pin hole, and the single slide pin hole is concentric with one of the first slide pin hole and the second slide pin hole,
a first slide pin received in and supported by the single slide pin hole and the one of the first slide pin hole and the second slide pin hole, and
a second slide pin received in and supported by the other of the first slide pin hole and the second slide pin hole,
wherein the first slide pin of the first brake caliper is received in and is supported by the single slide pin hole of the first brake caliper and the first slide pin hole of the first brake caliper, and
wherein the first slide pin of the second brake caliper is received in and is supported by the single slide pin hole of the second brake caliper and the second slide pin hole of the second brake caliper.

9. The set of brake calipers as defined in claim 8 wherein the second part of the first caliper is identical to the second part of the second caliper.

10. The set of brake calipers as defined in claim 8 wherein the second part of the first caliper is made from a first casting and the second part of the second caliper is made from a second casting, and the first casting is identical to the second casting.

11. The set of brake calipers as defined in claim 8 wherein the second part of the first caliper is made from a first forging and the second part of the second caliper is made from a second forging, and the first forging is identical to the second forging.

12. The set of brake calipers as defined in claim 8
wherein the first part of the first brake caliper has a first flange defining a first mounting surface for a first air actuator, and the first mounting surface is orientated relative to the joint plane of the first brake caliper in a first manner, and
wherein the first part of the second brake caliper has a second flange defining a second mounting surface for a second air actuator, and the second mounting flange is orientated relative to the joint plane of the second brake caliper in a second manner that is different from the first manner.

13. The set of brake calipers as defined in claim 12 wherein the first manner is an opposite handed manner to the second manner.

14. An axle comprising:
a first brake caliper and a second brake caliper each including:
a first side and a second side with a recess between the first side and the second side for receiving a brake rotor,
a housing for receiving a brake actuator mechanism, wherein the housing is located on the first side and includes a first part and a second part, the second part is positioned between the first part and the second side, the first part includes a single slide pin hole, the second part includes a first slide pin hole and a second slide pin hole, and the single slide pin hole is concentric with one of the first slide pin hole and the second slide pin hole,
a first slide pin received in and supported by the single slide pin hole and the one of the first slide pin hole and the second slide pin hole, and
a second slide pin received in and supported by the other of the first slide pin hole and the second slide pin hole,
wherein the first slide pin of the first brake caliper is received in and is supported by the single slide pin hole of the first brake caliper and the first slide pin hole of the first brake caliper,
wherein the first slide pin of the second brake caliper is received in and is supported by the single slide pin hole of the second brake caliper and the second slide pin hole of the second brake caliper, and
wherein the first brake caliper is located at a first end of the axle and the second brake caliper is located at a second end of the axle.
